(19) United States
(12) Patent Application Publication
(10) Pub. No.: US 2014/0097722 A1
(43) Pub. Date: Apr. 10, 2014

(54) ELECTROHYDRODYNAMIC (EHD) FLUID MOVER WITH COLLECTOR ELECTRODE LEADING SURFACE SHAPING FOR SPATIALLY SELECTIVE FIELD REDUCTION

(71) Applicant: Tessera, Inc., (US)

(72) Inventors: Nels Jewell-Larsen, San Jose, CA (US); Kenneth Honer, Santa Clara, CA (US); Gustavo Joseph, Oakland, CA (US); Ron Goldman, Oakland, CA (US); Matthew Schwiebert, Cupertino, CA (US)

(73) Assignee: TESSERA, INC., San Jose, CA (US)

(21) Appl. No.: 13/798,644

(22) Filed: Mar. 13, 2013

Related U.S. Application Data
(60) Provisional application No. 61/694,430, filed on Aug. 29, 2012.
(60) Provisional application No. 61/652,812, filed on May 29, 2012.

(51) Int. Cl. H02N 11/00

(52) U.S. Cl. CPC H02N 11/006
USPC 310/300

(57) ABSTRACT

In various electrohydrodynamic (EHD) fluid mover designs disclosed herein, electric field strength may be locally reduced in peripheral regions of an emitter-to-collector electrode gap. As a result, detrimental accumulations of silica, dust and other airborne contaminants can be reduced on surfaces in such peripheral regions, which may otherwise be susceptible to accumulations and/or difficult to clean or condition. In some cases, localized reduction in electric field near sidewall surfaces can provide desirable localized reductions in susceptibility to contaminant related spark or shunting current paths. In some cases, such as when a field blunting structure is employed and (as a result) a generally more uniform electric field pattern is provided locally, an engineered or purposeful local reduction both electric field strength and ion generation in peripheral regions of an emitter-to-collector electrode gap may be quite desirable.

### CROSS-REFERENCE TO RELATED APPLICATION(S)

The present application claims priority of Provisional Application Nos. 61/694,430, filed Aug. 29, 2012, and 61/652,812, filed May 29, 2012, each entitled “COMPACT ELECTROHYDRODYNAMIC (EHD) FLUID MOVER DESIGN.” The entirety of each of the foregoing applications is incorporated herein by reference.

### BACKGROUND

1. Field

The present application relates to devices that generate ions and electrical fields to motivate flow of fluids, such as air, and more particularly, to electric field and/or fluid flow shaping in electrohydrodynamic (EHD) air movers.

2. Related Art

Many modern electronic devices (including desktop and laptop computers, all-in-one computers, compute tablets, televisions, video displays and projectors) employ forced air flow as part of a thermal management solution. Mechanical air movers such as fans or blowers have conventionally been employed in many such devices. However, in some applications and devices, mechanical air mover operation may result in undesirable levels of noise or vibration that may degrade the user experience. In some cases, physical scale or flow paths that would otherwise be necessary to accommodate a mechanical air mover may be incompatible with, or unacceptably limit, the design, scale or form factor of a particular design. Worse still, at the extremely thin device form factors popular in certain consumer electronics (e.g., laptops, pad-type computers, televisions, smart phones, book readers and media players), mechanical air mover designs (if even accommodatable) tend to exhibit poor cooling efficiencies and/or performance. As a result, battery life and/or skin temperatures may be adversely affected or, as a practical matter, device performance throttled (or design limited) to a level compatible with passive cooling or acceptable acoustics.

Technologies have been developed that employ electric fields and principles of ionic movement of a fluid to motivate air flow. Devices that operate based on such principles are variously referred to in the literature as ionic wind machines, electric wind machines, corona wind pumps, electro-fluid-dynamics (EFD) devices, electrohydrodynamic (EHD) thrusters and EHD gas pumps. Some aspects of the technology have been exploited in devices referred to as electrostatic air cleaners or electrostatic precipitators and, indeed, some practical large scale device applications of the technology date back to the early 1900s. More recently, researchers have considered the utility of EHD air movers as part of a thermal management solution in consumer electronics devices. See generally, N. E. Jewell-Larsen, H. Ran, Y. Zhang, M. Schwiebert and K. A. Honer, Electrohydrodynamic (EHD) Cooled Laptop, in proceedings of 25th Annual Semiconductor Thermal Measurement and Management Symposium (March 2009).

In some cases, an ion flow or EHD air mover may improve cooling efficiency and thermal management in some devices and/or applications, while reducing noise, vibration and power consumption. Likewise, EHD air mover designs may provide or facilitate systems or devices that have reduced overall device lifetime costs, device size or volume, and/or improved electronic device performance or user experience.

In some cases and or operating environments, sidewalls of a flow channel in which fluid (e.g., air) is motivated may be, or become, susceptible to surface accumulations of contaminants or charge carriers that can (given local strength of an applied electric field) provide a spark or shunting current path between emitter and collector electrodes. This can be undesirable for a number of reasons including the acoustic signatures that can be generated, the surface pitting and damage that can occur and excess ozone (0₃) that can result.

Ozone (0₃), while naturally occurring, can also be produced during operation of various electronics devices including EHD devices, photocopiers, laser printers and electrostatic air cleaners, and by certain kinds of electric motors and generators, etc. At high concentrations, ozone can be undesirable and, accordingly, techniques to reduce ozone concentrations are desired. Indeed, techniques have been developed to catalytically or reactively break down ozone (O₃) into the more stable diatomic molecular form (O₂) of oxygen. See e.g., U.S. Pat. No. 6,603,268 to Lee and U.S. Patent Application Publication 2010-0116469, naming Jewell Larsen et al. as inventors, each of which is commonly-owned by the assignee of the present application.

Improved techniques are desired for shaping electric fields (and in some cases, fluid flows) in regions of the EHD air mover channel, particularly those adjacent sidewall surfaces.

### SUMMARY

It has been discovered that electric field strength may be locally reduced in peripheral regions of an emitter-to-collector electrode gap. As a result, detrimental accumulations of silica, dust and other airborne contaminants can be reduced on surfaces in such peripheral regions, which may otherwise be susceptible to accumulations and/or difficult to clean or condition. In some cases, localized reduction in electric field near sidewall surfaces can provide desirable localized reductions in susceptibility to contaminant related spark or shunting current paths. Indeed, in some cases, such as when a field blunting structure is employed and (as a result) a generally more uniform electric field pattern is provided locally, an engineered or purposeful local reduction both electric field strength and ion generation in peripheral regions of an emitter-to-collector electrode gap may be quite desirable. Specifically, EHD fluid mover designs have been developed that employ collector electrode leading surface shaping for spatially selective electric field strength reduction.

In some embodiments in accordance with the present invention(s), an apparatus includes an electrohydrodynamic (EHD) fluid mover that, in turn, includes (i) an elongate emitter electrode and (ii) one or more collector electrode surfaces, each extending laterally to at least substantially span a lateral dimension of a fluid flow channel. The collector electrode surfaces are spaced apart from the elongate emitter electrode and present one or more leading surfaces of a central portion thereof that are generally parallel to a longitudinal extent of the emitter electrode. The emitter and collector electrodes are energizable to establish a voltage therebetween, to generate ions along at least the central portion of the longitudinal extent of the elongate emitter electrode and to thereby motivate fluid flow in the channel. For a peripheral portion of the collector electrode surfaces closely proximate a lateral sidewall of the fluid flow channel, corresponding leading surface portions taper away from the elongate emitter electrode to provide a locally increased degree of spacing apart therefrom and to, when energized, provide a correspondingly reduced field strength in the region closely proximate the lateral sidewall.

In some cases or embodiments, the central portion constitutes more than about 80% of span of the collector electrode surfaces across the lateral dimension of the fluid flow channel. In some cases or embodiments, the increased degree of spacing apart provided in the peripheral portion closely proximate the lateral sidewall provides at least about 50% greater spacing apart from the elongate emitter electrode than provided in the central portion. In some cases or embodiments, the increased degree of spacing apart provided in the peripheral portion closely proximate the lateral sidewall provides at least about double (2×) the spacing apart from the elongate emitter electrode provided in the central portion. In some cases or embodiments, the taper presents a generally curved and electrostatically smooth transition in the increased degree of spacing apart provided in the peripheral portion.

In some embodiments, the apparatus further includes a field blunting structure positioned in the fluid flow channel just upstream of a portion of the longitudinal extent of the emitter electrode closely proximate the peripheral portion.

In some cases or embodiments, the taper is generally or entirely in the downstream direction. In some cases or embodiments, for a second peripheral portion of the collector electrode surfaces closely proximate an opposing lateral sidewall of the fluid flow channel, corresponding leading surface portions taper away from the elongate emitter electrode to provide a locally increased degree of spacing apart therefrom and to, when energized, provide a correspondingly reduced field strength in the region closely proximate the opposing lateral sidewall.

In some embodiments, the apparatus further includes a carriage movable to laterally transit the fluid flow channel and having conditioning surfaces configured to frictionally engage at least the leading surfaces of the central portion of the collector electrode surfaces during the lateral transit. In some cases or embodiments, the carriage includes a biasing cantilever to maintain frictional engagement of the conditioning surfaces with the leading collector electrode surfaces as the frictionally engaged conditioning surfaces transit between the central and peripheral portions. In some cases or embodiments, the frictionally engaged conditioning surfaces include a scraper configured to, at successive times throughout an operating life of the apparatus, at least partially mitigate accumulations of silica on the leading collector electrode surfaces.

In some embodiments, the apparatus further includes leading surface portion tapers away from the elongate emitter electrode at both opposing peripheral ends of the collector electrode surfaces. In some cases or embodiments, the carriage is stowable proximate at least one of the opposing peripheral ends to effectively provide an sidewall of the fluid flow channel. In some embodiments, the apparatus further includes a high-voltage power supply coupled to supply the emitter and collector electrodes with a nominal energizing voltage in excess of 3 KV.

In some cases or embodiments, the longitudinal extent of the emitter electrode is at least about 80 mm, and wherein a nominal emitter-to-collector electrode gap in the central portion and spacing between uppermost and lower most collector electrode surfaces are both less than about 2 mm. In some embodiments, the apparatus further includes ozone catalyst bearing heat transfer surfaces introduced into the flow channel downstream of the collector electrode surfaces to transfer heat into the motivated fluid flow.

In some embodiments, the apparatus further includes an enclosure having inlet and outlet ventilation boundaries, the EHD fluid mover disposed within the enclosure to, when energized, motivate air flow along a fluid flow path therebetween; and a heat source thermally coupled to transfer heat into the motivated air flow.

In some embodiments, the apparatus is configured to generate ions at least in part by a corona discharge established proximate the emitter electrode.

In some embodiments in accordance with the present invention, a method includes energizing elongate emitter and collector electrodes to establish a voltage therebetween, to generate ions along at least a central portion of the longitudinal extent of the elongate emitter electrode and to thereby motivate fluid flow in a fluid flow channel. The method further includes providing reduced field strength in a region of the fluid flow channel closely proximate a lateral sidewall based on a peripheral tapered portion of one or more collector electrode surfaces closely proximate the lateral sidewall, the peripheral tapered portion providing a locally increased degree of spacing apart from the elongate emitter electrode that, when energized the emitter and collector electrodes are energized, provides a correspondingly reduced field strength in the region closely proximate the lateral sidewall.

In some cases or embodiments, an opposing end peripheral tapered portion provided closely proximate an opposing lateral sidewall correspondingly reduces field strength in a region closely proximate the opposing lateral sidewall.

In some embodiments, the method further includes transiting an electrode conditioning carriage across the fluid flow channel to frictionally engage at least a central leading edge portion of the collector electrodes. In some embodiments, the method further includes biasing a cantilever to maintain frictional engagement of the conditioning surfaces of the electrode conditioning carriage with the leading collector electrode surfaces as the frictionally engaged conditioning surfaces transit between the central and peripheral portions. In some embodiments, the method further includes transiting an electrode conditioning carriage across the fluid flow channel while the emitter and collector electrodes sufficiently energized to maintain an ion generating corona discharge.

In some embodiments, the method further includes stowing an electrode conditioning carriage in a position that effectively defines a lateral sidewall of the fluid flow channel, wherein at least one field blunting structure projects from a sidewall of the fluid flow channel and at least one further field blunting structure projects into the fluid flow channel from a side of the stowed electrode conditioning carriage.

### BRIEF DESCRIPTION OF THE DRAWINGS

The present invention may be better understood, and its numerous objects, features, and advantages made apparent to those skilled in the art by referencing the accompanying drawings.

FIG. 1 illustrates basic principles of electrohydrodynamic (EHD) fluid acceleration.

FIG. 2 depicts an illustrative electrohydrodynamic (EHD) fluid mover configuration in which emitter and collector electrodes are energized to motivate fluid flow and in which a high voltage power supply is controlled in accordance with some embodiments of the present invention(s) to accommodate cooling or ventilation requirements of a system or device.

FIGS. 3A and 3B depict cross-sectional and perspective views (respectively) of an illustrative electrohydrodynamic (EHD) fluid mover configuration in which emitter and collector electrode surfaces are cleaned and/or conditioned using a mechanism that drives a carriage with surfaces in frictional engagement therewith. A drive motor is controlled in accordance with some embodiments of the present invention(s) to apply, in situ, a consumable ozone catalyst or reducer. In some embodiments, certain field blunting structures may facilitate carriage traversal of emitter and collector electrode surfaces even during EHD fluid mover operation.

FIGS. 4A, 4B, 4C, 4D and 4E depict various end-on and perspective views of an illustrative electrohydrodynamic (EHD) fluid mover configuration in which exemplary field blunting structures (e.g., both a sidewall-positioned field blunting structure and a carriage-positioned, field blunting structure) and collector electrode shaping (e.g., tapered leading surfaces at or adjacent sidewalls) are employed. In the illustrated configuration, fluid flow impeding baffles are provided as flow obstructing surfaces that are formed integrally with the trailing edge of a collector electrode.

FIGS. 5A, 5B, and 5C depict perspective, top and end-on views of an illustrative carriage for use in an electrohydrodynamic (EHD) fluid mover configuration such as described herein. Exemplary field blunting structures are employed on opposing lateral sides of the carriage, together with a downstream baffle portion integral with the carriage and various surfaces that facilitate frictional cleaning of collector electrode surfaces. An emitter electrode passes through the interior of the carriage and frictionally engages conditioning surfaces that are not visible in the current views. Successive FIGS. 6A, 6B, 6C, 7A, 7B, and 7C further interior view details of the illustrated carriage.

FIGS. 6A, 6B, and 6C depict additional perspective, top and end-on views in which an upper surface of the carriage is removed (in the depiction) to reveal interior details including a set of conductive projections through which the emitter electrode travels. In the illustrated embodiment, the conductive projections provide a conductive path to electrically couple the emitter electrode to the field blunting structures and to frictionally engage the emitter electrode wire to clean and/or condition same.

FIGS. 7A, 7B, and 7C depict perspective, top and end-on views similar to those of the preceding views, but with the lower surface of the illustrated carriage and waste capture material/structures further removed from view to reveal, in somewhat greater detail, operation of a biasing member on a medial one of the conductive projections to provide increased frictional engagement of cleaning/conditioning blocks and to facilitate reliable electrical contact between the emitter wire and field blunting structures.

FIGS. 8A and 8B depict a variation on the previously described embodiments in which a loop emitter electrode travels past generally fixed cleaning/conditioning blocks.

The use of the same reference symbols in different drawings indicates similar or identical items. System and device exploitations of the various configurations described and illustrated herein will be appreciated by persons of ordinary skill in the art having benefit of the present disclosure.

### DETAILED DESCRIPTION

As will be appreciated, many of the designs and techniques described herein have particular applicability to the thermal management challenges of densely-packed devices and small form-factors typical of modern consumer electronics. Indeed, some of the EHD fluid/air mover designs and techniques described herein facilitate active thermal management in electronics whose thinness or industrial design precludes or limits the viability of mechanical air movers such as fans, blowers, etc. In some embodiments, such EHD fluid/air movers may be fully integrated in an operational system such as a pad-type or laptop computer, a projector or video display device, a set-top box, etc. In other embodiments, such EHD fluid/air movers may take the form of subassemblies or enclosures adapted for use in providing such systems with EHD motivated flows.

In general, a variety of scales, geometries and other design variations are envisioned for electrostatically operative surfaces that provide field shaping or that functionally constitute a collector electrode, together with a variety of positional interrelationships between such electrostatically operative surfaces and the emitter and/or collector electrodes of a given EHD device. For purposes of illustration, we focus on certain exemplary embodiments and certain surface profiles and positional interrelationships with other components. For example, in much of the description herein, generally planar collector electrodes are formed as or on respective parallel surfaces that define opposing walls of a fluid flow channel and which are positioned proximate to a corona discharge-type emitter wire that is displaced (upstream) from leading portions of the respective collector electrodes. Nonetheless, other embodiments may employ other configurations or other ion generation techniques and will nonetheless be understood in the descriptive context provided herein.

For purposes of illustration and not limitation, contents of U.S. Provisional Application No. 61/612,892, filed Mar. 19, 2012, entitled “OPERATIONAL CONTROL OF ELECTROHYDRODYNAMIC (EHD) AIR MOVER AND ELECTRODE CONDITIONING MECHANISM” and of U.S. patent application Ser. No. 13/737,464, filed Jan. 9, 2013, entitled “ELECTROHYDRODYNAMIC (EHD) AIR MOVER CONFIGURATION WITH FLOW PATH EXPANSION AND/OR SPREADING FOR IMPROVED OZONE CATALYSIS” and naming Jewell-Larsen, Lee, Honer and Humpston as inventors are incorporated herein by reference. The '892 provisional application and the '464 application illustrate and describe certain laptop and display device deployments of EHD air movers. In addition, the '892 and '464 applications illustrate and describe variations on electrode geometries that, based on teachings herein, may be adapted to convey benefits and advantages analogous to those described herein. Further alternative EHD fluid mover configurations are detailed in application Ser. No. 13/310,676, filed Dec. 2, 2011, entitled “ELECTROHYDRODYNAMIC (EHD) FLUID MOVER WITH FIELD SHAPING FEATURE AT LEADING EDGE OF COLLECTOR ELECTRODES” and naming Jewell-Larsen as inventor, which is also incorporated herein by reference.

In the present application, some aspects of embodiments illustrated and described herein are referred to as electrohydrodynamic fluid accelerator devices, also referred to as “EHD devices,” “EHD fluid accelerators,” “EHD fluid movers,” “ion fluid movers” and the like. For purposes of illustration, some embodiments are described relative to particular EHD device configurations in which a corona discharge at, or proximate to, an emitter electrode operates to generate ions that are accelerated in the presence of an electrical field, thereby motivating fluid flow. While corona discharge-type devices provide a useful descriptive context, it will be understood (based on the present description) that other ion generation techniques may also be employed. For example, in some embodiments, techniques such as silent discharge, AC discharge, dielectric barrier discharge (DBD), or the like, may be used to generate ions that are in turn accelerated in the presence of an electrical field and motivate fluid flow.

Using heat transfer surfaces that, in some embodiments, take the form of heat transfer fins, heat dissipated by electronics (e.g., microprocessors, graphics units, etc.) and/or other components can be transferred to the EHD motivated fluid flow and exhausted from an enclosure through a ventilation boundary. Typically, when a thermal management system is integrated into an operational environment, heat transfer paths (often implemented as heat pipes or using other technologies) are provided to transfer heat from where it is dissipated (or generated) to a location (or locations) within the enclosure where air flow motivated by an EHD device (or devices) flows over heat transfer surfaces.

For illustration, heat transfer fins are depicted with respect to various exemplary embodiments. However, as will be appreciated based on the description herein, in some embodiments, conventional arrays of heat sink fins need not be provided and EHD motivated fluid flow over exposed interior surfaces, whether proximate a heat generating device (such as a processor, memory, RF section, optoelectronics or illumination source) or removed therefrom, may provide sufficient heat transfer. In each case, provision of ozone catalytic or reactive surfaces/materials on heat transfer surfaces may be desirable. Typically, heat transfer surfaces, field shaping surfaces and dominant ion collecting surfaces of a collector electrode present differing design challenges and, relative to some embodiments, may be provided using different structures or with different surface conditioning. However, in some embodiments, a single structure may be both electrostatically operative (e.g., to shape fields or collect ions) and provide heat transfer into an EHD motivated fluid flow.

### Electrohydrodynamic (EHD) Fluid Acceleration, Generally

Basic principles of electrohydrodynamic (EHD) fluid flow are well understood in the art and, in this regard, an article by Jewell-Larsen, N. et al., entitled “Modeling of corona-induced electrohydrodynamic flow with COMSOL multiphysics” (in the Proceedings of the ESA Annual Meeting on Electrostatics 2008) (hereafter, “the Jewell-Larsen Modeling article”), provides a useful summary. Likewise, U.S. Pat. No. 6,504,308, filed Oct. 14, 1999, naming Krichtafovitch et al. and entitled “Electrostatic Fluid Accelerator” describes certain electrode and high voltage power supply configurations useful in some EHD devices. U.S. Pat. No. 6,504,308, together with sections I (Introduction), II (Background), and III (Numerical Modeling) of the Jewell-Larsen Modeling article are hereby incorporated by reference herein for all that they teach.

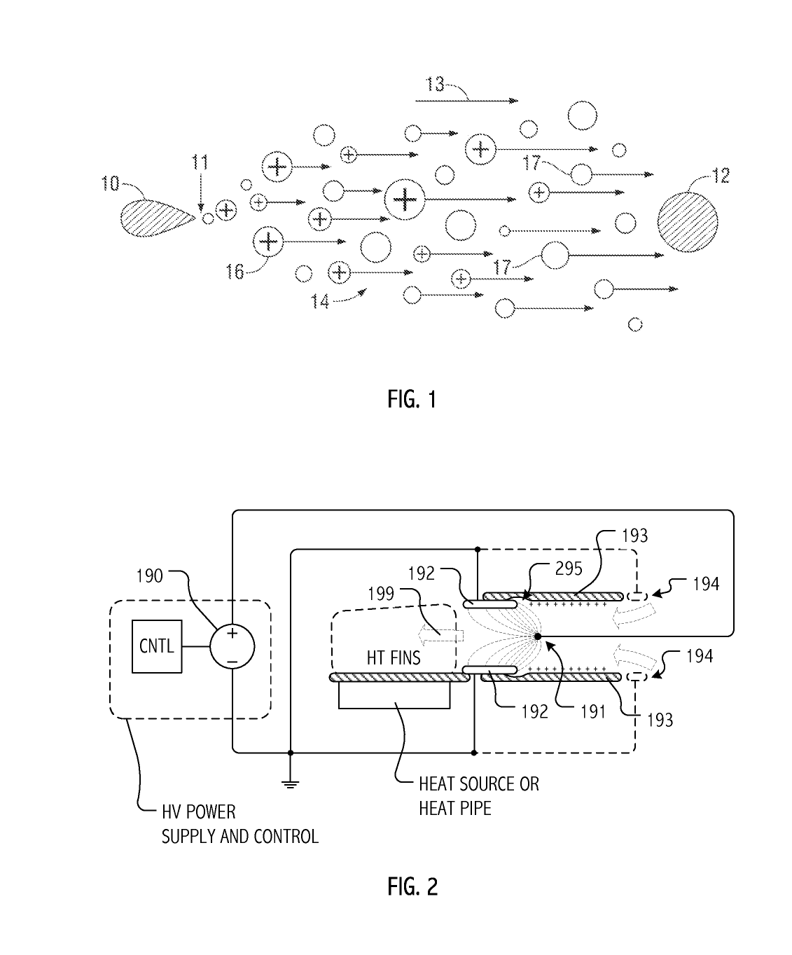

Summarizing briefly with reference to the illustration in FIG. 1, EHD principles include applying a high intensity electric field between a first electrode 10 (often termed the “corona electrode,” the “corona discharge electrode,” the “emitter electrode” or just the “emitter”) and a second electrode 12. Fluid molecules, such as surrounding air molecules, near the emitter discharge region 11 become ionized and form a stream 14 of ions 16 that accelerate in the electric field toward second electrode 12, colliding with neutral fluid molecules 17 in the process. As a result of these collisions, momentum is transferred from the stream 14 of ions 16 to the fluid molecules 17, imparting corresponding movement of the fluid molecules 17 in a desired fluid flow direction, denoted by arrow 13, toward second electrode 12. Second electrode 12 may be variously referred to as the “accelerating,” “attracting,” “target” or “collector” electrode. While stream 14 of ions 16 is attracted to, and generally neutralized by, second electrode 12, the momentum transferred to the neutral fluid molecules 17 carries them past second electrode 12 at a certain velocity. The movement of fluid produced by EHD principles has been variously referred to as “electric,” “corona” or “ionic” wind and has been defined as the movement of gas induced by the movement of ions from the vicinity of a high voltage discharge electrode 10.

EHD fluid mover designs illustrated herein generally include a single elongate wire, corona discharge type emitter electrode, although (more generally) multiple emitter electrodes and other emitter geometries may be employed. Typically, corona discharge type emitter electrodes include a portion (or portions) that exhibit(s) a small radius of curvature and may take the form of a wire, rod, edge or point(s). Other shapes for corona discharge electrodes are also possible; for example, the corona discharge electrode may take the shape of barbed wire, wide metallic strips, and serrated plates or non-serrated plates having sharp or thin parts that facilitate ion production at the portion of the electrode with the small radius of curvature when high voltage is applied. In general, corona discharge electrodes may be fabricated in a wide range of materials. For example, in some embodiments, a corona discharge type emitter electrode is formed of Palladium Nickel (PdNi) plated Tungsten (W) wire with a Rhodium (Rh) coating. U.S. application Ser. No. 13/302,811, filed Nov. 22, 2011, which is incorporated herein by reference, describes certain layered structures of drawn wire that, at diameters of 10-50 μm (typically less that about 25 μm) are suitable for EHD air mover devices of the illustrated designs with KV range emitter-to-collector voltages and scales typical of modern consumer electronics. In some embodiments, compositions such as described in U.S. Pat. No. 7,157,704, filed Dec. 2, 2003, entitled “Corona Discharge Electrode and Method of Operating the Same” and naming Krichtafovitch et al. as inventors may be employed. U.S. Pat. No. 7,157,704 is incorporated herein for the limited purpose of describing materials for some emitter electrodes that may be employed in some corona discharge-type embodiments. In general, a high voltage power supply creates the electric field between corona discharge electrodes and collector electrodes.

EHD fluid mover designs illustrated herein include ion collection surfaces positioned downstream of one or more corona discharge electrodes. Often, ion collection surfaces of an EHD fluid mover portion include leading surfaces of generally planar collector electrodes extending downstream of the corona discharge electrode(s). In small form factor designs that seek to minimize flow channel height, collector electrode surfaces may be positioned against, or may partially define opposing walls of, the flow channel. In some cases, a collector electrode may do double-duty as heat transfer surfaces. In some cases, a fluid permeable ion collection surface may be provided.

In general, collector electrode surfaces may be fabricated of, or with, any suitable conductive material or surface, such as aluminum or copper. Alternatively, as disclosed in U.S. Pat. No. 6,919,698 to Krichtafovitch, collector electrodes (referred to therein as “accelerating” electrodes) may be formed of a body of high resistivity material that readily conducts a corona current, but for which a result voltage drop along current paths through the body of high resistivity collector electrode material provides a reduction of surface potential, thereby damping or limiting an incipient sparking event. Examples of such relatively high resistance materials include carbon filled plastic, silicon, gallium arsenide, indium phosphide, boron nitride, silicon carbide, and cadmium selenide. U.S. Pat. No. 6,919,698 is incorporated herein for the limited purpose of describing materials for some collector electrodes that may be employed in some embodiments. Note that in some embodiments described herein, a surface conditioning or coating of high resistivity material (as contrasted with bulk high resistivity) may be employed.

### Illustrative EHD Air Mover and Energizing Power Supply

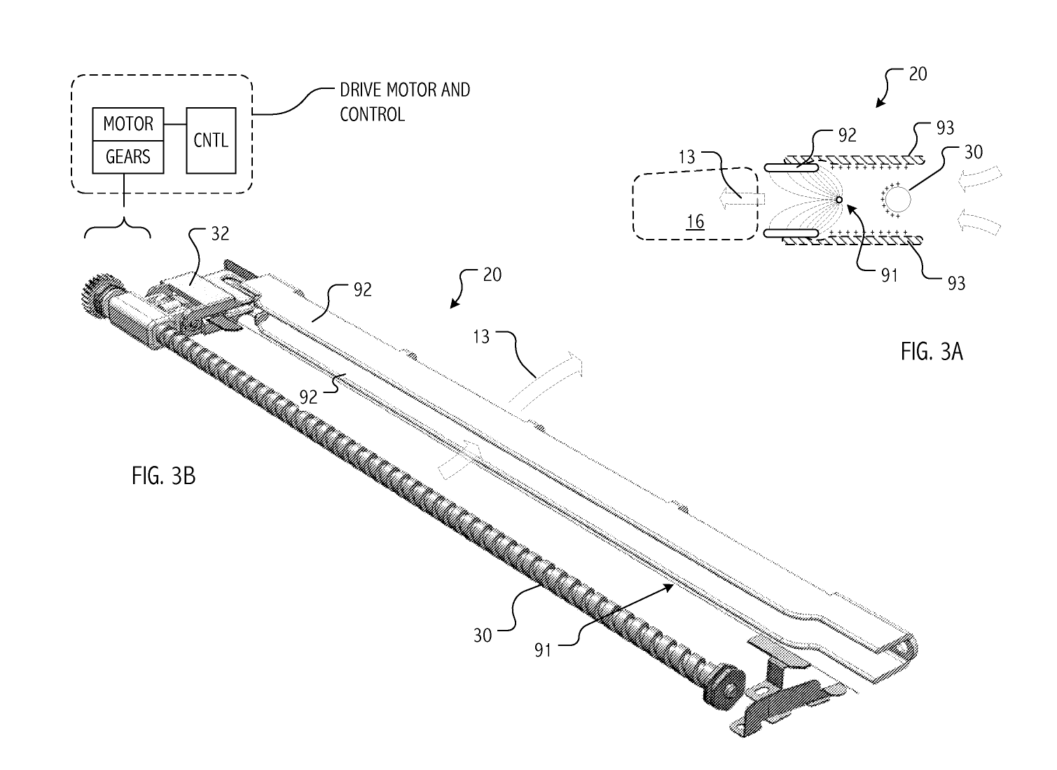

FIG. 2 depicts an illustrative EHD fluid mover configuration (with an illustrative power supply circuit schematic overlaid thereon) in which a high voltage power supply 190 is coupled between an emitter electrode 191 and collector electrodes 192 to generate an electric field and in some cases ions that motivate fluid flow 199 in a generally downstream direction. In the illustration, emitter electrode 191 is coupled to a positive high voltage terminal of power supply 190 (illustratively +6 KV, although specific voltages and, indeed, any supply voltage waveforms may be matters of design choice) and collector electrodes 192 are coupled to a local ground. Suitable designs for power supply 190 (and controls therefor) are detailed in the aforementioned U.S. Provisional Application No. 61/612,892, filed Mar. 19, 2012, and in U.S. Provisional Application No. 61/647,483, filed May 15, 2012, entitled “OPERATIONAL CONTROL OF AN ELECTROHYDRODYNAMIC (EHD) FLUID MOVER,” each of which is incorporated herein by reference.

Given the substantial voltage differential and short distances involved between emitter electrode 191 and leading surfaces of collector electrodes 192 (perhaps 5 mm or less, depending on EHD fluid mover scale), a strong electrical field is developed which imposes a net downstream motive force on positively charged ions (or particles) in the fluid. Field lines illustrate (generally) spatial aspects of the resulting electric field and spacing of the illustrated field lines is indicative of field strength.

As will be understood by persons of ordinary skill in the art, corona discharge principles may be employed to generate ions in the intense electric field closely proximate the surface of a corona-discharge type emitter electrode. Thus, in corona discharge type embodiments in accord with FIG. 2, fluid molecules (such as surrounding air molecules) near emitter electrode 191 become ionized and the resulting positively charged ions are accelerated in the electric field toward collector electrodes 192, colliding with neutral fluid molecules in the process. As a result of these collisions, momentum is transferred from the ions to neutral fluid molecules, inducing a corresponding movement of fluid molecules in a net downstream direction. While the positively charged ions are attracted to, and neutralized by, collector electrodes 192, the neutral fluid molecules move past collector electrodes 192 at an imparted velocity (as indicated by fluid flow 199). The movement of fluid produced by corona discharge principles has been variously referred to as “electric,” “corona” or “ionic” wind and has generally been defined as the movement of gas induced by the movement of ions from the vicinity of a high voltage discharge electrode.

Notwithstanding the descriptive focus on corona discharge type emitter electrode configurations, persons of ordinary skill in the art will appreciate that ions may be generated by other techniques such as silent discharge, AC discharge, dielectric barrier discharge (DBD), or the like, and once generated, may, in turn, be accelerated in the presence of electrical fields to motivate fluid flow as described herein. For avoidance of doubt, emitter electrodes need not be of a corona discharge type in all embodiments. Also for avoidance of doubt, power supply voltage magnitudes, polarities and waveforms (if any) described with respect to particular embodiments are purely illustrative and may differ for other embodiments.

### Illustrative Cleaning/Conditioning Mechanism

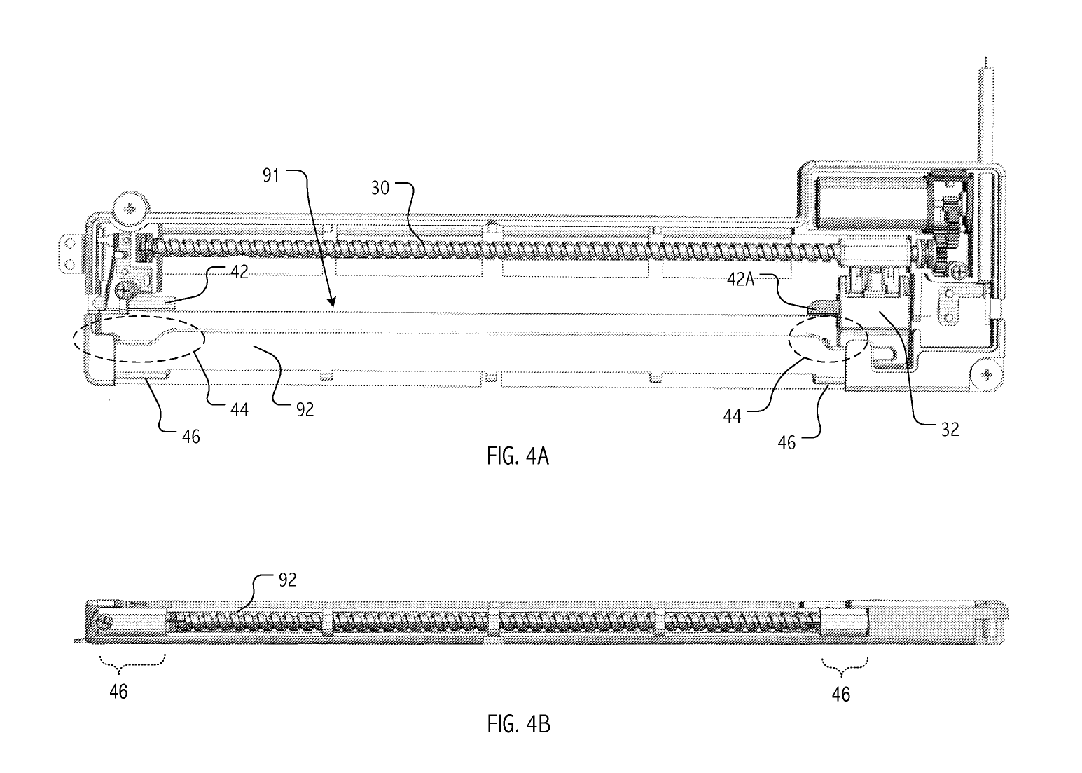

FIGS. 3A and 3B depict (in respective cross-sectional and perspective views) an EHD air mover assembly 20 in which an upstream lead screw or worm gear 30 driven carriage 32 is provided to transit electrode conditioning and/or cleaning surfaces over at least a portion of an elongate, wire-type, mid-channel emitter electrode 91 and a pair of closely-spaced elongate collector electrode surfaces 92. When energized with high voltage (typically multi-KV voltage supplied from power supply terminals that have been omitted for clarity), an ion flux from emitter electrode 91 to collector electrodes 92 is generated and air flow 13 results based on mechanisms such as previously described.

In the illustrated cross-sectional view of FIG. 3A, EHD motivated airflow 13 travels past heat transfer surface(s) 16 (in some cases, a plurality of metallic fins) that may be thermally coupled (e.g., by heat spreader, heat pipe or the like) to heat surfaces for which a thermal management solution is to be provided. Dielectric top and bottom wall surfaces at least partially define a channel through which air flow is motivated and, in the illustrated embodiment, collector electrode surfaces 92 are positioned generally thereagainst. In situ cleaning and/or conditioning of respective electrode surfaces, including in situ conditioning of emitter electrode 91 with a conditioning material that includes silver (Ag) will understood based on the description herein.

Further details regarding cleaning/conditioning mechanisms for in situ application of a consumable catalyst that includes silver (Ag) to an emitter electrode of certain EHD air mover configurations such as illustrated herein may be found in U.S. patent application Ser. No. 13/602,256, filed Sep. 3, 2012, entitled “System and Method for In-Situ Conditioning of Emitter Electrode with Silver” and naming Jewell-Larsen, Honer, Gao and Schwiebert as inventors, which is incorporated herein by reference.

In the illustrated perspective view of FIG. 3B, an illustrative drive mechanism including lead screw or worm gear 30 driven carriage 32 is provided to transit electrode conditioning and/or cleaning surfaces over at least a portion of the elongate, wire-type, mid-channel emitter electrode 91 and a pair of closely-spaced elongate collector electrode surfaces 92. Drive motor and control circuits are operated in accord with the description herein to control operation of a drive motor that engages (typically with reduction gearing) the lead screw or worm gear 30. Further details (including drawings and description of suitable control circuits and strategies) may be found in the aforementioned U.S. Provisional Application Nos. 61/612,892, filed Mar. 19, 2012, and 61/647,483, filed May 15, 2012, each of which is incorporated herein by reference.

### Illustrative Field Blunting Structures, Collector Shaping and Baffles

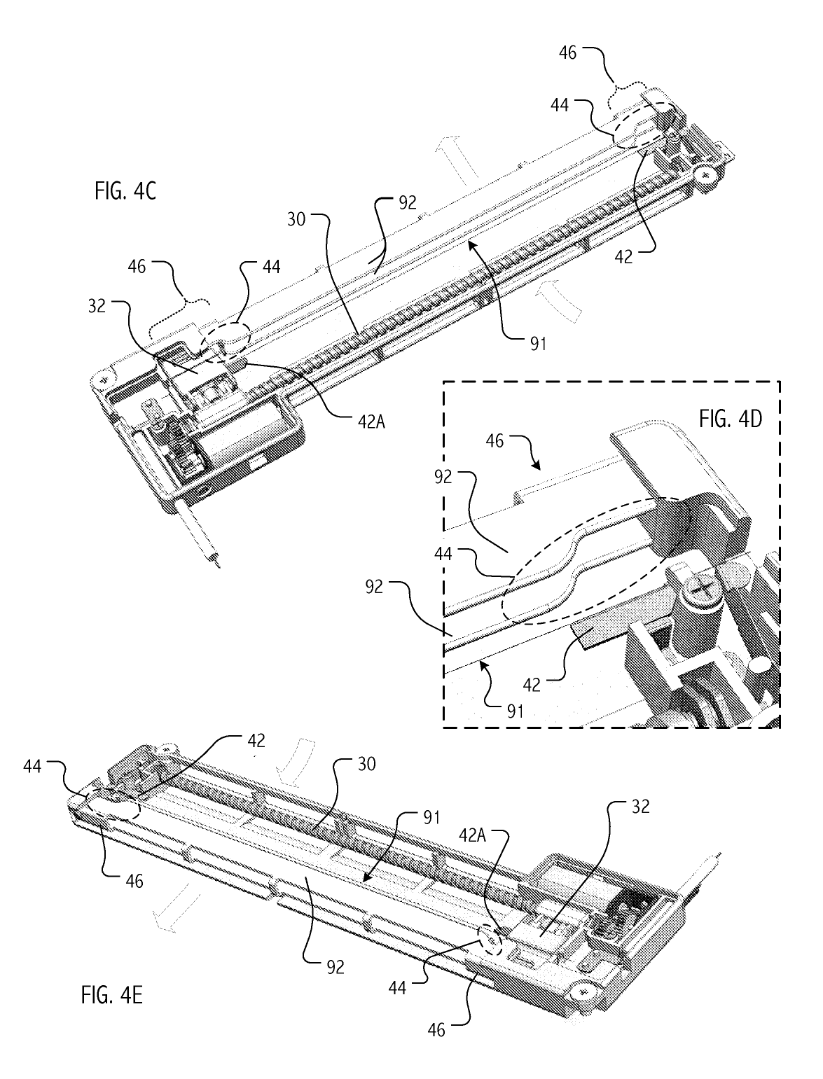

FIGS. 4A, 4B, 4C, 4D and 4E depict various end-on and perspective views of an illustrative EHD air mover configuration in which exemplary field blunting structures (e.g., sidewall-positioned field blunting structure 42 and carriage-positioned, field blunting structure 42A) are employed. Collector electrode shaping (e.g., tapered leading surfaces 44) and fluid flow impeding baffles are also employed in the illustrated design and are described in greater detail below.

It has been discovered that certain surfaces in an EHD air mover design (at least in compact designs at or below the scales illustrated and described herein) are particularly susceptible to accumulation of airborne contaminants and charge, which (in the presence of substantial electric fields) may, in turn, create conditions suitable for sparking discharge. Sidewalls of an EHD air mover channel adjacent to emitter and collector electrodes (or into which the lateral extent of such electrodes impinges) are one example of such susceptible surfaces. Another example, in some embodiments, is sidewalls of an electrode conditioning carriage configured to travel across an EHD air mover channel. EHD air mover designs illustrated and described herein employ several strategies to mitigate these susceptibilities which may otherwise lead to undesirable sparking discharge. In general, mitigation strategies may be used individually, or in combination, in various contemplated embodiments. Accordingly, mitigation strategies are described individually, but combined use will also be understood and appreciated based on the description herein.

A first such strategy includes use of structures to “blunt” the electric field in a spatially selective way near such susceptible surfaces. In general, the physical design of a corona discharge type emitter electrode seeks to focus electric field strength so as to establish and maintain a region of corona discharge closely proximate to the emitter electrode surface. However, by physically augmenting or scaling some of the electrode (or other physically or capacitively-coupled) surfaces that are coupled (or charge up) to emitter supply voltage, it is possible to locally increase the effective cross-section or radius of the emitter electrode at locations adjacent to the aforementioned susceptible surfaces. In this way, the strength of the electric field closely proximate to such susceptible surfaces can be reduced in an engineered and spatially selective way to below that necessary for corona onset. In such designs, ion generation and flux in the region closely proximate susceptible surfaces can be reduced and it has been discovered that, as a result, incidence of sparking discharge along otherwise susceptible sidewall surfaces may be effectively managed. Note that in some embodiments, the corona may be locally suppressed using field blunting structures while, in others, corona discharge may simply be reduced.

As explained elsewhere herein and/or as will be appreciated by persons of ordinary skill in the art having benefit of the present disclosure, corona discharge is, in general, sustainable in a region adjacent an emitter electrode and in which field strength is of sufficient intensity to ionize air molecules. For example, in embodiments such as described and illustrated herein (given a typical voltage of about 6 KV, emitter wire diameters of about 20 μm and emitter-to-collector electrode distances of about 2 mm), a corona may be sustained in conditions (e.g., temperature, pressure, humidity and constituents) typical for consumer electronics out to a few tens of microns from collector facing surfaces of the emitter wire. By distributing high voltage potential over an effectively larger emitter cross-section, field strength can be reduced in a spatially selective way near surfaces susceptible to sparking discharge proximate to locally suppress (or at least reduce) corona discharge. Thus, to locally provide an effectively-larger emitter cross-section, a sidewall-positioned field blunting structure 42 and a carriage-positioned, field blunting structure 42A are provided in the form of conductive metal tabs.

In the embodiment(s) illustrated in FIGS. 4A-4E, field blunting structures (42, 42A) are electrically connected to emitter electrode 91 potential. However, in other embodiments, field blunting structures may be coupled to a differing potential or supply. Furthermore, in some embodiments, one or more field blunting structures need not have an electrically conductive path to supply voltages, but may instead float to an electrostatically coupled potential (e.g., based on proximity to emitter electrode 91). While field blunting structures may be formed of ozone resistant conductive materials such as stainless steel or nickel based alloys, other materials such as polyether ether ketone (PEEK) or polycarbonates may be employed in some embodiments. Indeed, while conductive materials or coatings are suitable, it will understood based on the present description that materials or coatings in field blunting structures need not be particularly good conductors so long as some degree of electron mobility is provided.

In embodiments without a carriage, instances of field blunting structure 42 may be provided at opposing sidewalls. In embodiments in which a movable carriage (e.g., carriage 32) may be parked at one end (or the other) to, in effect, define a lateral sidewall of the EHD channel, a carriage-positioned, field blunting structure 42A may be provided. In embodiments in which it is desirable to energize electrodes (e.g., emitter electrode 91 and collector electrodes 92) when a movable carriage (e.g., carriage 32) is positioned, or is travelling, in the channel away from sidewalls (e.g., laterally mid-channel in the EHD air mover), instances (e.g., a pair) of carriage-positioned, field blunting structures 42A may be provided on opposing sides of the movable carriage and instances (e.g., a pair) of sidewall-positioned field blunting structures 42 may be provided at, or adjacent to, sidewalls of the EHD channel.

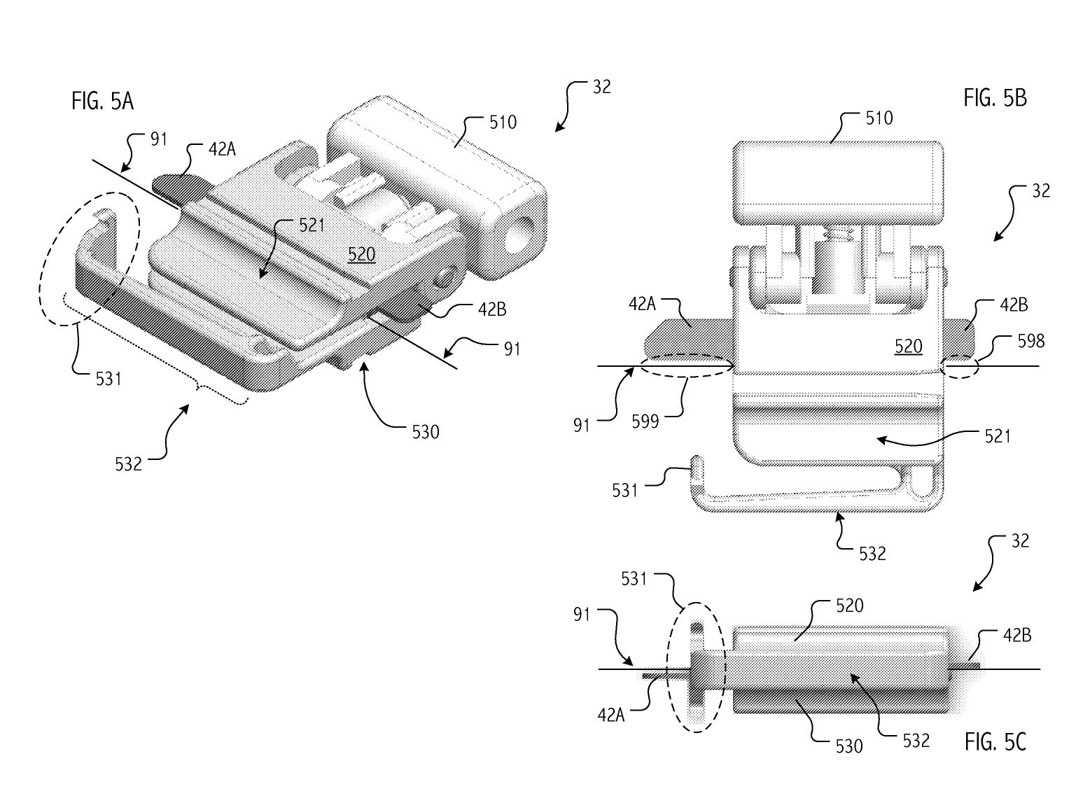

Note that, in embodiments in which a field blunting structure is provided both on a carriage and at a sidewall toward which the carriage may travel (e.g., field blunting structures 42A, 42), corresponding carriage- and sidewall-positioned field blunting structures may be offset (e.g., vertically in the illustrated views) to allow overlap and more complete end-to-end travel of carriage 32 and its electrode conditioning surfaces across at least a full central portion of the electrodes. Alternatively, or additionally, recesses may be provided at sidewalls and/or carriage sidewalls to accommodate (or further accommodate) end-to-end travel of carriage 32 and its electrode conditioning surfaces. FIGS. 5A-5C, 6A-6C and 7A-7C depict a carriage design (with successive layers of interior detail and emitter electrode conditioning surfaces revealed) in which a pair of carriage-positioned, field blunting structures 42A and 42B are provided.

Although conductive metal tabs are illustrated (relative to FIGS. 4A-4E) for field blunting structures 42, 42A, other structures and materials may be employed to similar effect in other embodiments. For example, more bulbous and less streamlined structures may be employed in some embodiments though, perhaps, with somewhat reduced flow cross-section through the channel. Metallic field blunting structures are possible, as are field blunting structures formed of (or faced with) other materials including conductive plastics. Even structures formed of (or faced with) dielectric material may be employed in some embodiments to accumulate charge to effectively increase emitter cross-section, and thereby providing the field blunting effects described herein. Furthermore, while field blunting structures are illustrated (in FIGS. 4A-4E) as closely proximate to emitter wire 91, but structurally distinct therefrom, it will also be appreciated that, in some embodiments, field blunting structures may be formed integrally with, or affixed to, an emitter electrode. Note that field blunting structures are typically be positioned (or extend) just upstream of collector-facing surfaces of an emitter electrode so as not to, themselves, become part of a sparking discharge path.

FIGS. 5A-5C, 6A-6C and 7A-7C depict, in somewhat greater detail, a design for an illustrative movable carriage (e.g., carriage 32) in which a pair of carriage-positioned, field blunting structures 42A and 42B are provided. A larger one (42A) of the field blunting structures is configured to project into the EHD flow channel when carriage 32 is stowed (recall the stowed position illustrated in FIGS. 4A, 4C and 4E) against, or effectively as, a sidewall of the flow channel through the EHD air mover. Thus, during EHD air mover operation with carriage 32 stowed, i.e., when emitter and collector electrodes (91, 92) are energized with high voltage sufficient to establish a corona discharge, field blunting structure 42A provides corona suppression (or at least reduction) along a corresponding portion 599 of emitter electrode 91 adjacent the corresponding carriage sidewall that, in the stowed position (recall FIGS. 4A, 4C and 4E), in effect constitutes a sidewall of the flow channel through the EHD air mover.

In addition, an optional and, in the illustrated embodiment, smaller one (42B) of the field blunting structures is provided on the opposing sidewall of carriage 32. Although field blunting structure 42B is not readily discernible in the views of FIGS. 4A, 4C and 4E, it will be appreciated that an appropriate recess may be provided in the illustrated EHD air mover assembly frame to accommodate field blunting structure 42B, if provided. In those embodiments in which it is optionally provided, field blunting structure 42B provides corona suppression (or at least reduction) along a corresponding portion 598 of emitter electrode 91. In this way, corona suppression or reduction may be provided when carriage 32 is deployed within the flow channel through the EHD air mover. For example, in some embodiments, it may be desirable to continue to operate the EHD air mover with emitter and collector electrodes (91, 92) energized with high, though possibly reduced, voltage sufficient to establish a corona discharge even during carriage traversal across the flow channel. In such embodiments or operational modes, the pair of field blunting structures 42A, 42B, provide corona suppression or reduction adjacent to both sidewall surfaces of carriage 32 that may be susceptible to ion accumulation and sparking discharge if/when carriage 32 is traversing or positioned mid-channel.

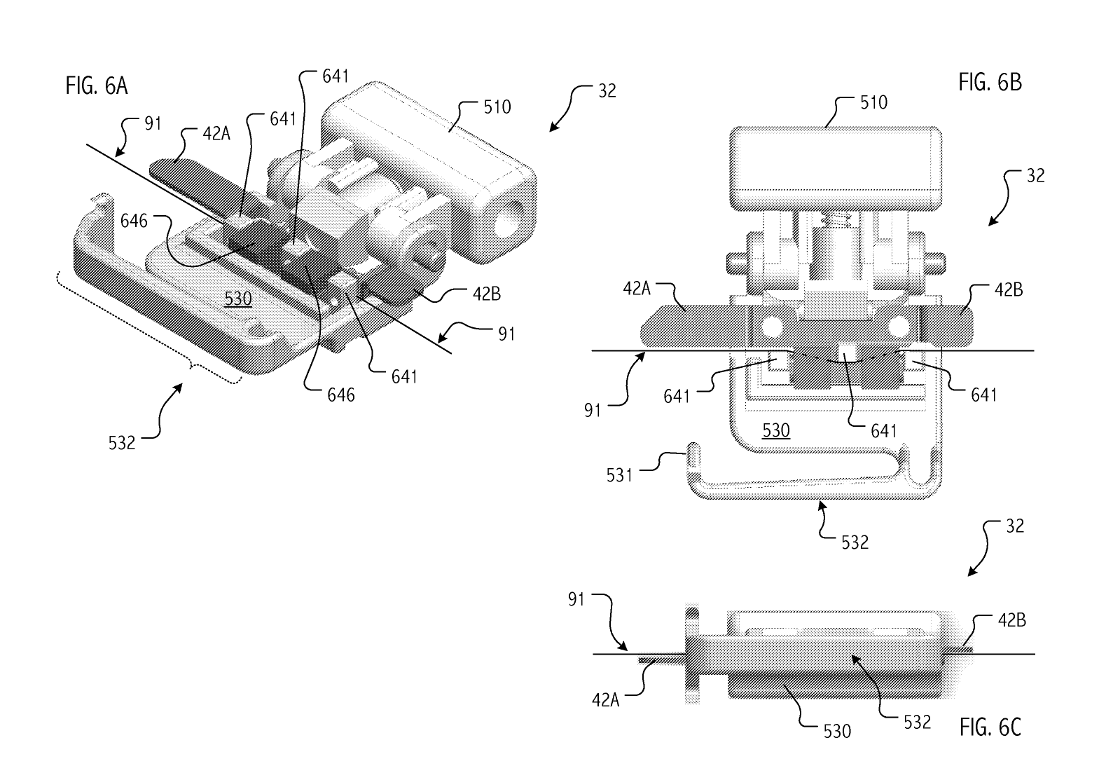

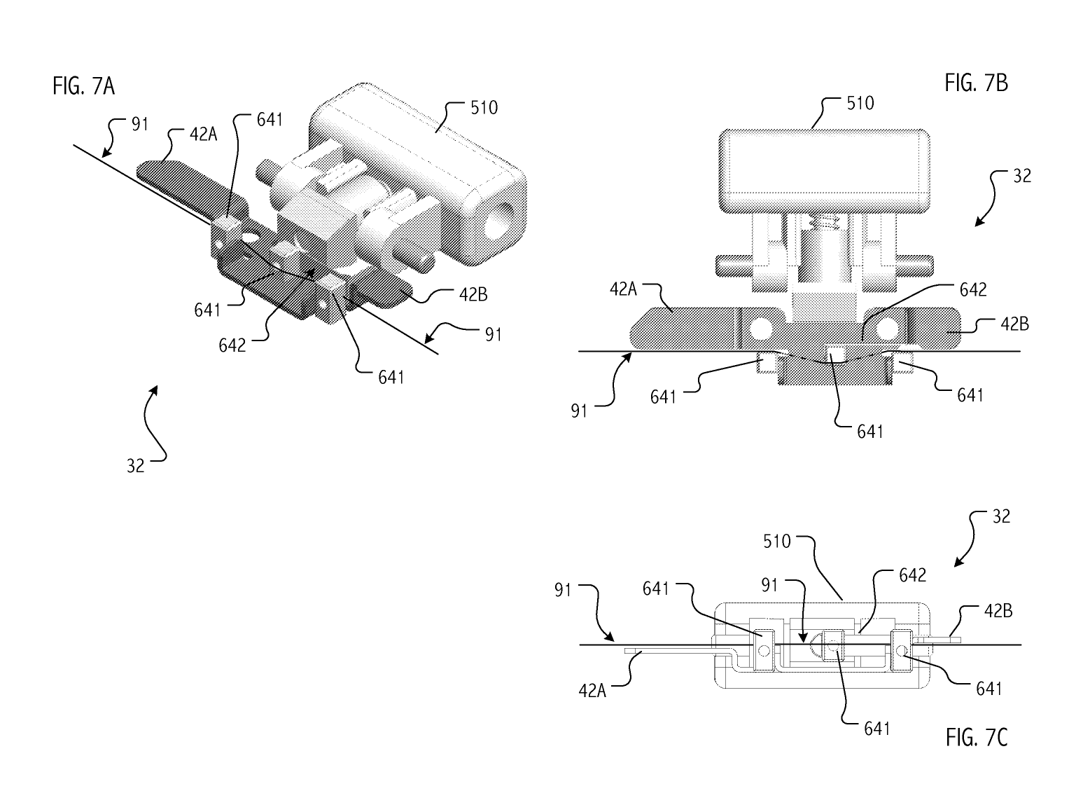

Note that in the embodiments of carriage 32 illustrated in FIGS. 5A-5C (and/or FIGS. 6A-6C and 7A-7C), field blunting structure 42A exhibits greater lateral projection and provides more substantial field blunting than structure 42B so as to accommodate generally higher EHD operating power levels when carriage 32 is stowed (as compared to generally lower EHD operating power levels if/when carriage 32 is traversing or positioned mid-channel). Of course, in some embodiments, operating power levels may be more uniform and/or field blunting structures 42A and 42B may be more similarly sized.

Referring now to FIGS. 6A-6C and 7A-7C and to the interior detail of carriage 32 revealed thereby, it is notable that emitter electrode 91 (a wire electrode) is threaded in a generally serpentine path through a trio of conductive metal pins 641 arranged in a biased, interdigitated configuration to maintain frictional contact with emitter electrode 91. Note that in some embodiments, one or more of the conductive metal pins 641 electrically connect (by frictional conductor-to-conductor contact) field blunting structures 42A, 42B to voltages (typically multi-KV supply voltages) that energize emitter electrode 91, thereby increasing the localized effective cross-section of the emitter electrode 91 (as described above) adjacent the susceptible sidewalls of carriage 32 and/or of the channel itself. In some embodiments in accordance with FIGS. 6A-6C and 7A-7C, conductive metal pins 641 comprise silver (Ag) and/or an alloy or compound thereof such that frictional contact with pins 641 tends to deposit ozone catalytic amounts of silver on emitter electrode 91. In addition in some embodiments, a serpentine path (such as illustrated) tends to elastically deform emitter electrode 91 and thereby break up otherwise detrimental accumulations of silica or other materials thereon. In some embodiments, electrical and frictional contact, as well as an elastically deforming serpentine path, are maintained over a useful life cycle of the EHD device despite wear of the illustrated silver comprising pins 641 at least in part by biasing opposing surfaces (e.g., using biasing spring 642).

Referring back now to FIGS. 4A-4E, additional strategies may be employed in some embodiments to mitigate susceptibilities to contaminant and charge accumulation, which may (as previously described) otherwise lead to undesirable sparking discharge. A second such strategy includes electrode shaping to reduce electric field strength in a spatially-selective way near sidewall surfaces susceptible to contaminant and/or charge accumulation.

In general, the physical design and relative positioning of emitter and collector electrodes seek to maximize a portion of the flow channel in which an electric field can accelerate charged airflow constituents (e.g., ions and/or charged particulate resulting from corona discharge). However, by creating or accentuating an emitter-to-collector gap near susceptible sidewall surfaces, it is possible to reduce the field conditions that can contribute to sparking discharge. Specifically, by locally increasing an emitter-to-collector gap (e.g., by providing collector taper 44 at or near sidewall surfaces and thereby locally increasing the distance between emitter 91 and collector 92 surfaces), both magnitude and shaping of the electric field can be defined in an engineered spatially selective way to guide ions and charged particulate away from sidewall surfaces and to reduce field strength at the sidewalls. In this way, both the propensity of susceptible sidewall surfaces to accumulate contaminants and charge and the susceptibility of such surfaces (even with some charge or contaminants accumulated thereon) to sparking discharge can be reduced.

Furthermore, and as described elsewhere herein, in those embodiments in which in situ electrode cleaning and conditioning is provided for either or both of an emitter electrode and a collector electrode (e.g., for emitter electrode 91 and collector electrodes 92 using carriage 32), it will be understood by persons of ordinary skill in the art having access to the present disclosure that the ability frictionally engage and effectively remove debris from electrode surfaces all the way up to an impingement on sidewall surfaces may be limited. See FIGS. 5A-5C for exploded detail on exemplary frictionally-engaged collector cleaning surfaces of carriage 32, particularly cantilever biased scraper 531 and pad surfaces 521, that in the more macro scale depictions of FIGS. 4A, 4C and 4E are configured to travel over and frictionally engage leading edges and exposed surfaces of collector electrodes 92, respectively. Likewise see FIGS. 6A-6C and 7A-7C for exploded detail on exemplary frictionally-engaged emitter cleaning surfaces housed within carriage 32, particularly metal pins 641 and conformal foam or abrasive matrix 646.

By providing collector tapers 44 such as illustrated in FIGS. 4A, 4C, 4D and 4E at or near sidewall surfaces, it is possible to ensure that the major interior span of emitter and collector electrodes 91, 92 (in which emitter-to-collector voltage provides maximal field strength) is subject to a “full wipe” and those minor outer portions (coinciding generally with the illustrated collector electrode tapers 44) for which frictionally-engaged cleaning has limited reach are exposed to lesser field strength due to the increased local emitter-to-collector distance. For example, in the interior span (between the illustrated opposing end tapers 44), strength of the field may (given typical operating conditions and form factors) be in excess of 2 KV/mm, while strength of the field near tapers 44 and adjacent sidewalls may be less than 1.0-1.5 KV/mm.

Likewise, although a particular taper in leading surfaces of an upper/lower collector electrode configuration is illustrated, persons of ordinary skill in the art will appreciate a range of variations on shaping and presentation of leading surfaces to provide similar effect. In some embodiments, recesses may be provided in sidewalls of the flow channel and/or sidewall-positioned field blunting structure 42 and carriage-positioned, field blunting structure 42A may be just slightly offset relative to one another (e.g., in a vertical dimension) to allow more complete side-to-side travel of carriage 32. Note that in the embodiments illustrated in FIGS. 4A-4E, tapers 44 increase emitter-to-collector distance by 50-100% as compared to nominal values mid-channel and begin 5-10 mm from corresponding sidewalls (or effective sidewalls) of the EHD channel. Note that, notwithstanding the concreteness of the illustrated embodiments, specific distances, taper patterns and onsets are all matters of design choice and may differ in other embodiments or for differing conditions or operating environments.

Still yet a third strategy may be employed in some embodiments to complement either or both of the field blunting and collector shaping strategies described above to mitigate susceptibilities to contaminant and charge accumulation, which may (as previously described) otherwise lead to undesirable sparking discharge. Specifically, and again referring back again to FIGS. 4A-4E, fluid flow impeding baffles are provided as flow obstructing surfaces (46) to address effects of a low pressure well that may otherwise be induced in regions of diminished corona current or even corona suppression, such as for example, peripheral regions of an emitter-to-collector electrode gap adjacent sidewalls where either or both of the aforementioned design techniques (field blunting and collector shaping) have been employed.

To mitigate device inefficiencies that could otherwise result from a low-pressure-well-induced vortex and to limit contaminant delivering vortex-type flows at sidewalls, a fluid flow baffle is provided downstream of leading surfaces of the collector electrode. By interrupting a backflow path into the portion of the EHD channel adjacent to the sidewalls (or effective sidewall(s)), fluid flow baffles such as provided by surfaces 46 effectively prevent formation of a vortex involving peripheral lateral portions of the flow channel in which spatially selective corona suppression (or reduction) and/or field reduction tends to locally quench the motive EHD forces that are otherwise active in the major interior portion of the EHD channel.

Note that, in some embodiments, fluid flow baffles may be formed integrally with the trailing edge of collector electrode 92, such as with the baffle 46 instance illustrated in cutaway detail in FIG. 4D. Alternatively (or additionally), a similar fluid flow baffle may be provided further upstream such as within the gap between upper and lower surfaces of collector electrode 92. In such cases, it can be desirable to form baffle 46 of a conductive material, e.g., in some cases, monolithically with the conductive metal of collector electrode 92, itself. In general, it is desirable to position a fluid flow baffle close as possible to the sidewall-proximate portion of the emitter-to-collector gap where corona suppression and/or field suppression resulting from field blunting tab 42 and/or collector taper 44 creates the local absence (or reduction) in motive force conditions which may otherwise allow for formation of a low-pressure well induce vortex. Of course, electrostatic design complexity increases as the fluid flow baffle moves closer to (or indeed into) the emitter-to-collector gap. In addition, the ability to effectively clean or condition lateral extremities of electrode surfaces (e.g., in designs that employ a travelling carriage 32 such as illustrated and described herein) may be affected by baffle designs that place a rigid immovable baffle close to emitter electrode 91, leading surfaces collector electrode 92, or within the gap therebetween.

Notwithstanding the aforementioned complexities, embodiments are envisioned in which a fluid flow baffle (or an additional fluid flow baffle) is provided closer to (or indeed with) the emitter-to-collector gap. In some cases, a flexible baffle formed of dielectric material in of close to the emitter-to-collector gap may be provided and still accommodate electrostatic design goals and/or electrode surface cleaning/conditioning requirements. In some cases, a fluid flow baffle (or an additional fluid flow baffle) may be provided upstream of the emitter electrode.

More generally, desirable sizing and placement of fluid flow baffles is a function of localized corona current reductions or suppression (e.g., at sidewalls or adjacent a movable carriage) in a particular EHD device configuration. Based on the description herein, persons of ordinary skill in the art will appreciate a range of variations on shaping and placement of baffles to provide similar effect.

In addition to flow baffles at channel sidewalls (or effective sidewalls), it will be appreciated by persons of ordinary skill in the art having benefit of the present disclosure that similar issues present if/when the EHD air mover supports operational modes in which emitter and collector electrodes 91, 92 are energized with high, though possibly reduced, voltage sufficient to establish a corona discharge even during carriage traversal across the flow channel. In such embodiments or operational modes, the pair of field blunting structures 42A, 42B, provide corona suppression or reduction adjacent to both sidewall surfaces of carriage 32 and tend to locally quench the motive EHD forces that are active elsewhere in the EHD channel. As a result, it has been found to be advantageous to provide a back flow impeding baffle that travels with carriage 32. For example, in embodiments illustrated in FIGS. 5A-5C and 6A-6C, a downstream projecting portion of the carriage 32 design, e.g., the biasing cantilever that urges scraper 531 against leading surfaces of collector electrodes 92, is engineered to provide a travelling flow impeding baffle 532 to backflows that might otherwise develop into vortices involving low pressure wells induced on either side of carriage 32 localized corona suppression (or reduction) described above relative to field blunting tabs 42A and 42B.

Note that, while fluid flow impeding baffles are useful in combination with field blunting and/or collector shaping techniques described herein, low pressure-well-induced vortex effects may present in designs in which field blunting structures and/or collector shaping are omitted or provided in some materially differing way. For example, low pressure-well-induced vortices may form near sidewall terminations of electrodes. Accordingly, it will be understood that fluid flow impeding baffles such as described herein may be advantageously be employed even in EHD fluid mover embodiments that do not provide the field blunting structures and/or collector shaping described hereinabove.

### Other Aspects of an Illustrative Carriage Design

In addition to the previously-described, spatially-selective corona suppression, field reduction and/or use of fluid flow baffles, further aspects of an exemplary and illustrative carriage 32 design are now described with reference to the series of depictions (and successive layers of interior detail revealed) in FIGS. 5A-5C, 6A-6C and 7A-7C. Indeed, design, electrostatic operation and travel of carriage 32 (recall FIGS. 4A, 4C and 4E) within an operative embodiment of a EHD fluid mover may better understood with reference FIGS. 5A-5C, 6A-6C and 7A-7C and the further description that follows.

FIGS. 5A, 5B, and 5C depict perspective, top and end-on views of an illustrative carriage 32 for use in an electrohydrodynamic (EHD) fluid mover configuration such as described herein (recall FIGS. 3B and 4A-4E). In the illustrated embodiment, a threaded nut 510 is used in conjunction with rotating screw or worm gear to cause carriage 32 to travel laterally along emitter electrode 91 and collector electrodes (which are omitted to avoid obfuscating the present views). Exemplary field blunting structures 42A and 42B are employed on opposing lateral sides of the carriage and are electrically coupled to emitter wire 91 using interior structures described in greater detail with respect to the additional views of FIGS. 6A-6C and 7A-7C. Accordingly, as previously described and indeed even when (or if) an EHD air mover operates with energized electrodes during traversal of emitter electrode 91, field blunting structures 42A and 42B of carriage 32 tend to locally suppress corona discharge along portions 599 of emitter electrode 91 immediately adjacent thereto.

In the illustrated embodiment, a downstream baffle portion is provided integral with the carriage to reduce low pressure well flow vortices in the portion of the EHD flow channel where, based on field blunting structures 42A and 42B and presence of dielectric carriage body portions (520 and 530) in the emitter-to-collector electrode gap, corona discharge may be effectively suppressed. In addition, various surfaces including (i) a surface 521 that supports frictionally engaged pads or other surfaces conformal with upper and lower ones of the collector electrodes (not visible in the views of FIGS. 5A-5C, but recall FIGS. 4A-4E) to frictionally engage a lower one of the collector electrodes and (ii) scraper surfaces 531 to frictionally engage leading edge surfaces of such collector electrodes all facilitate frictional cleaning of collector electrodes 92. Emitter electrode 91 passes through the interior of the carriage (between upper surface portion 520 and lower surface portion 530) and frictionally engages conditioning surfaces that are not yet visible in the present views.

FIGS. 6A, 6B, and 6C, in turn, depict perspective, top and end-on views similar to those of FIGS. 5A, 5B, and 5C, but with an upper surface portion 520 of the illustrated carriage removed to reveal interior details including a set of conductive projections 641 through which emitter electrode 91 is threaded. In the illustrated embodiment, conductive projections 641 provide an electrically conductive path to electrically couple emitter electrode 91 to field blunting structures 42A and 42B and to frictionally engage (and elastically deform) the wire of emitter electrode 91 to clean and/or condition same. Positioning and biasing of a medial one of conductive projections 641 with respect to the others provide (i) consistent and reliable electrical contact with, (ii) frictional engagement with, and (iii) elastic deformation of the emitter electrode wire as carriage 32 travels along the emitter and collector electrodes of the EHD fluid mover. In the illustrated configuration, conductive projections 641 comprise silver and thereby facilitate in situ conditioning of the emitter electrode 91 by deposition of consumable ozone reducing material at various and successive times throughout the operating life of the EHD fluid mover.

Note that the design of carriage 32, particularly the provision of field blunting structures 42A and 42B on the travelling carriage itself and provision of downstream baffle 532, facilitate operation of EHD air mover (with energized emitter and collector electrodes) during carriage traversal thereacross. More specifically, by spreading field lines emanating from an energized emitter wire (e.g., from a portion of emitter electrode 91 immediately adjacent to the carriage sidewalls) over a larger effective surface of field blunting structures 42A and 42B, corona discharge may be locally suppressed immediately in the region adjacent to the carriage sidewalls. This, in turn, tends to reduce the risk of sparking discharge via charge populations that may otherwise accumulate on dielectric body portions of carriage 32 in the emitter-to-collector electrode gap.

In addition to silver comprising conductive projections 641, waste capture material and/or structures 646 are provided to retain at least a portion of the silica and other detrimental materials (e.g., dendrites and glassy coatings that can form on emitter electrode 91 based on chemical constituents in the motivated air flow and/or chemical reactions that may occur in the corona) that are scraped or otherwise removed from emitter electrode 91 by elastic deformation of the wire electrode in frictional engagement with projections 641. In some cases, capture material and/or structures 646 include foam or other compliant matrix through which emitter wire electrode 91 cuts a path during carriage traversal. In this way, hard silica waste that might otherwise embed in the silver comprising conductive projections 641 and thereafter wear or otherwise degrade the outer surface of emitter electrode 91 may instead be effectively sequestered in the foam or compliant matrix of waste capture material/structures 646.

FIGS. 7A, 7B, and 7C depict perspective, top and end-on views similar to those of the preceding views, but with the lower surface portion 530 of the illustrated carriage and waste capture material/structures 646 further removed from view to reveal in greater detail operation of a biasing member 642 on a medial one of the conductive projections 641 to provide effective frictional engagement of cleaning/conditioning blocks (here silver comprising conductive projections 641) and the effective and reliable electrical coupling between emitter wire electrode 91 and field blunting structures 42A and 42B as previously described.

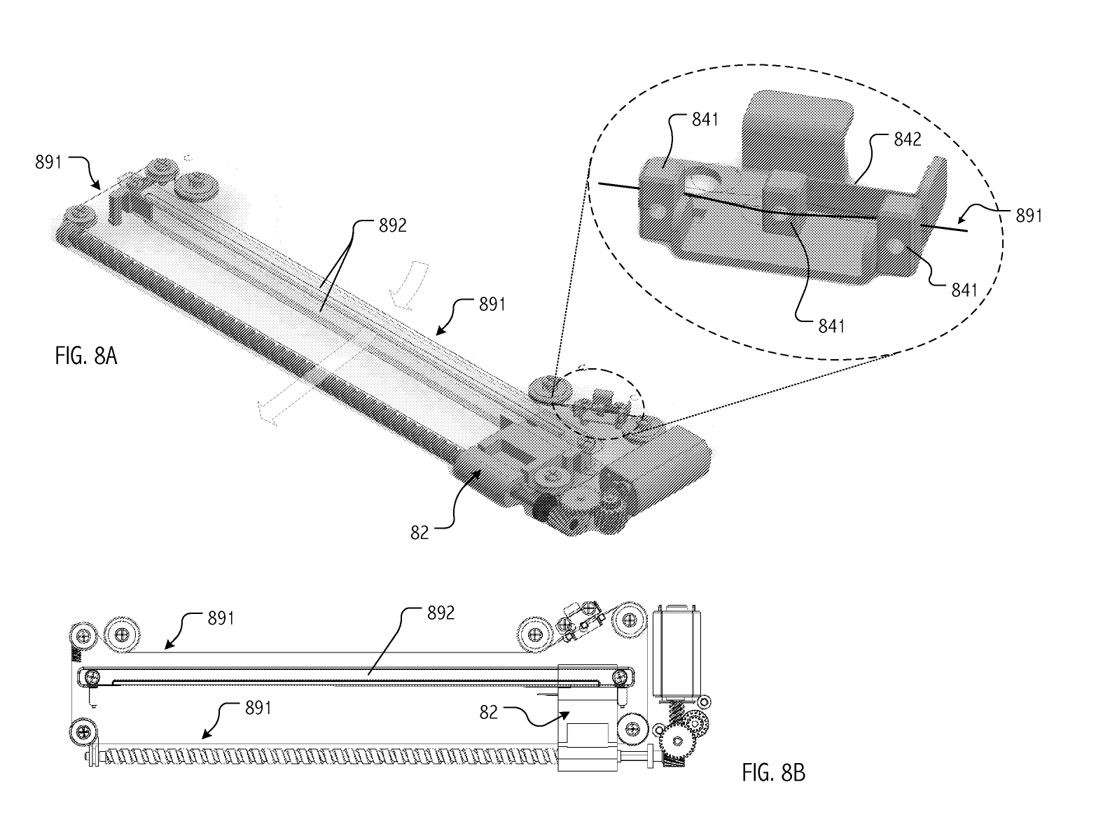

While embodiments have been described in which cleaning, conditioning and indeed, application of ozone reducing material to an emitter electrode are facilitated by travel of a movable carriage over a fixed emitter electrode, it will be understood that embodiments are also envisioned in which an emitter wire (e.g., in a loop or spooling configuration) travels past a generally fixed set of cleaning and/or conditioning surfaces. FIGS. 8A and 8B depict one such illustrative variation on the previously described embodiments in which a loop emitter electrode 891 travels past generally fixed silver comprising projections 841. As before, a biasing member (here, biasing member 842) on a medial one of projections 841 provides effective frictional engagement of cleaning/conditioning blocks (here silver comprising projections 841) against travelling emitter electrode 891. In the illustrated embodiment, a screw or worm driven carriage 82 engages along emitter electrode 891 to travel in frictional engagement across surfaces of collector electrodes 892 while, at the same time, advancing emitter electrode 891 past silver comprising projections 841. Other embodiments may provide other suitable mechanisms for advancing emitter electrode 891.

### Other Embodiments

While the techniques and implementations of the EHD devices discussed herein have been described with reference to exemplary embodiments, it will be understood by those skilled in the art that various changes may be made and equivalents may be substituted for elements thereof without departing from the scope of the appended claims. For example, while particular field blunting structures, collector tapers and baffle placements have been illustrated and described, persons of ordinary skill in the art having benefit of the present disclosure will appreciate that other suitable implementations are also contemplated. In some cases, field blunting structures or collector tapers or baffles illustrated and described herein may be omitted while still preserving some of the structures and/or advantages described herein.

Although operative embodiments have been illustrated and/or described herein with respect to a particular illustrative power supply voltage configuration in which emitter electrodes are coupled to high positive voltage, field shaping dielectric surfaces accumulate positive charge, and collector electrodes are coupled to ground, it will be appreciated by persons of ordinary skill in the art having access to the present disclosure that other configurations are also possible. Grounded emitter embodiments are contemplated, as are embodiments in which voltages coupled to emitter and collector electrodes straddle a ground potential or have different polarity.

In addition, many modifications may be made to adapt a particular situation or material to the teachings without departing from the essential scope thereof. Therefore, the particular embodiments, implementations and techniques disclosed herein, some of which indicate the best mode contemplated for carrying out these embodiments, implementations and techniques, are not intended to limit the scope of the appended claims.

What is claimed is:

1. An apparatus comprising:
an electrohydrodynamic (EHD) fluid mover including (i) an elongate emitter electrode and (ii) one or more collector electrode surfaces, each extending laterally to at least substantially span a lateral dimension of a fluid flow channel,
the collector electrode surfaces spaced apart from the elongate emitter electrode and presenting one or more leading surfaces of a central portion thereof that are generally parallel to a longitudinal extent of the emitter electrode,
wherein the emitter and collector electrodes are energizable to establish a voltage therebetween, to generate ions along at least the central portion of the longitudinal extent of the elongate emitter electrode and to thereby motivate fluid flow in the channel, and
wherein for a peripheral portion of the collector electrode surfaces closely proximate a lateral sidewall of the fluid flow channel, corresponding leading surface portions taper away from the elongate emitter electrode to provide a locally increased degree of spacing apart therefrom and to, when energized, provide a correspondingly reduced field strength in the region closely proximate the lateral sidewall.

2. The apparatus of claim 1,
wherein the central portion constitutes more than about 80% of span of the collector electrode surfaces across the lateral dimension of the fluid flow channel.

3. The apparatus of claim 1,
wherein the increased degree of spacing apart provided in the peripheral portion closely proximate the lateral sidewall provides at least about 50% greater spacing apart from the elongate emitter electrode than provided in the central portion.

4. The apparatus of claim 1,
wherein the increased degree of spacing apart provided in the peripheral portion closely proximate the lateral sidewall provides at least about double (2×) the spacing apart from the elongate emitter electrode provided in the central portion.

5. The apparatus of claim 1,
wherein the taper presents a generally curved and electrostatically smooth transition in the increased degree of spacing apart provided in the peripheral portion.

6. The apparatus of claim 1, further comprising:
a field blunting structure positioned in the fluid flow channel just upstream of a portion of the longitudinal extent of the emitter electrode closely proximate the peripheral portion.

7. The apparatus of claim 1,
wherein the taper is generally or entirely in the downstream direction.

8. The apparatus of claim 1,
wherein for a second peripheral portion of the collector electrode surfaces closely proximate an opposing lateral sidewall of the fluid flow channel, corresponding leading surface portions taper away from the elongate emitter electrode to provide a locally increased degree of spacing apart therefrom and to, when energized, provide a correspondingly reduced field strength in the region closely proximate the opposing lateral sidewall.

9. The apparatus of claim 1, further comprising:
a carriage movable to laterally transit the fluid flow channel and having conditioning surfaces configured to frictionally engage at least the leading surfaces of the central portion of the collector electrode surfaces during the lateral transit.

10. The apparatus of claim 9,
wherein the carriage includes a biasing cantilever to maintain frictional engagement of the conditioning surfaces with the leading collector electrode surfaces as the frictionally engaged conditioning surfaces transit between the central and peripheral portions.

11. The apparatus of claim 9,
wherein the frictionally engaged conditioning surfaces include a scraper configured to, at successive times throughout an operating life of the apparatus, at least partially mitigate accumulations of silica on the leading collector electrode surfaces.

12. The apparatus of claim 1, further comprising:
leading surface portion tapers away from the elongate emitter electrode at both opposing peripheral ends of the collector electrode surfaces.

13. The apparatus of claim 12,
wherein the carriage is stowable proximate at least one of the opposing peripheral ends to effectively provide a sidewall of the fluid flow channel.

14. The apparatus of claim 1, further comprising:
a high-voltage power supply coupled to supply the emitter and collector electrodes with a nominal energizing voltage in excess of 3 KV.

15. The apparatus of claim 1,
wherein the longitudinal extent of the emitter electrode is at least about 80 mm, and wherein a nominal emitter-to-collector electrode gap in the central portion and spacing between uppermost and lower most collector electrode surfaces are both less than about 2 mm.

16. The apparatus of claim 1, further comprising:
ozone catalyst bearing heat transfer surfaces introduced into the flow channel downstream of the collector electrode surfaces to transfer heat into the motivated fluid flow.

17. The apparatus of claim 1, further comprising:
an enclosure having inlet and outlet ventilation boundaries, the EHD fluid mover disposed within the enclosure to, when energized, motivate air flow along a fluid flow path therebetween; and
a heat source thermally coupled to transfer heat into the motivated air flow.

18. The apparatus of claim 1, configured to generate ions at least in part by a corona discharge established proximate the emitter electrode.

19. A method comprising:
energizing elongate emitter and collector electrodes to establish a voltage therebetween, to generate ions along at least a central portion of the longitudinal extent of the elongate emitter electrode and to thereby motivate fluid flow in a fluid flow channel; and
providing reduced field strength in a region of the fluid flow channel closely proximate a lateral sidewall based on a peripheral tapered portion of one or more collector electrode surfaces closely proximate the lateral sidewall, the peripheral tapered portion providing a locally increased degree of spacing apart from the elongate emitter electrode that, when energized the emitter and collector electrodes are energized, provides a correspondingly reduced field strength in the region closely proximate the lateral sidewall.

20. The method of claim 19,
wherein an opposing end peripheral tapered portion provided closely proximate an opposing lateral sidewall correspondingly reduces field strength in a region closely proximate the opposing lateral sidewall.

21. The method of claim 19, further comprising:
transiting an electrode conditioning carriage across the fluid flow channel to frictionally engage at least a central leading edge portion of the collector electrodes.

22. The method of claim 21, further comprising:
biasing a cantilever to maintain frictional engagement of the conditioning surfaces of the electrode conditioning carriage with the leading collector electrode surfaces as the frictionally engaged conditioning surfaces transit between the central and peripheral portions.

23. The method of claim 19, further comprising:
transiting an electrode conditioning carriage across the fluid flow channel while the emitter and collector electrodes sufficiently energized to maintain an ion generating corona discharge.

24. The method of claim 19, further comprising:
stowing an electrode conditioning carriage in a position that effectively defines a lateral sidewall of the fluid flow channel,
wherein at least one field blunting structure projects from a sidewall of the fluid flow channel and at least one further field blunting structure projects into the fluid flow channel from a side of the stowed electrode conditioning carriage.
